(19) United States
(12) Patent Application Publication
(10) Pub. No.: US 2019/0366351 A1
(43) Pub. Date: Dec. 5, 2019

(54) SHREDDER ASSEMBLY

(71) Applicants: BRYANT D CALLOWAY, SWANSEA, IL (US); GILLIAN J CALLOWAY, SWANSEA, IL (US)

(72) Inventors: BRYANT D CALLOWAY, SWANSEA, IL (US); GILLIAN J CALLOWAY, SWANSEA, IL (US)

(21) Appl. No.: 15/993,951

(22) Filed: May 31, 2018

(51) Int. Cl. B02C 18/00; B02C 21/02

(52) U.S. Cl. CPC B02C 18/0007; B02C 2018/0046; B02C 21/02

(57) ABSTRACT

A shredder assembly for shredding paper comprising: a frame; a bag; a base, where the base engages the frame and bag during use; an opening within the base; and a shredder positioned over the opening. The frame includes a top support that receives and supports the base, where the frame includes vertical supports and a cross bar support between the vertical supports. The shredder assembly may also include wheels that are mounted under the vertical supports.

### BACKGROUND OF THE INVENTION

### Field of Invention

The present invention relates to a portable shredder assembly.

### Description of Related Art

Document shredders are used widely in business for shredding documents that need to be destroyed for waste purposes. Many companies shred documents to avoid the disclosure of information that may be within the documents prior to disposal. Sensitive information may be within the documents and businesses cannot disclose such information to the public. Further in order to protect identities of various clients and client's information, it may be imperative to kept such data strictly confidential. Therefore the use of shredders is widespread in various business environments.

### SUMMARY OF THE INVENTION

The present invention relates to a shredder assembly for shredding paper comprising: a frame; a bag; a base, where the base engages the frame and bag during use; an opening within the base; and a shredder positioned over the opening. The frame includes a top support that receives and supports the base, where the frame includes vertical supports and a cross bar support between the vertical supports. The shredder assembly may also include wheels that are mounted under the vertical supports.

### BRIEF DESCRIPTION OF DRAWINGS

FIG. 1 depicts an exploded view of the components related to the shredder assembly in accordance with the present invention.

FIG. 2 depicts the complete shredder assembly in assembled form.

### DETAILED DESCRIPTION

The present invention relates to a portable shredder assembly that enables convenient shredding of documents. The shredder assembly includes a small shredder that may be placed upon a base that seals around a top support of a frame. The base further seals a bag in place that extends from the top of the frame to receive shredded paper that is fed through the shredder. The frame preferably includes the wheels that allow for the free movement of the shredder as needed.

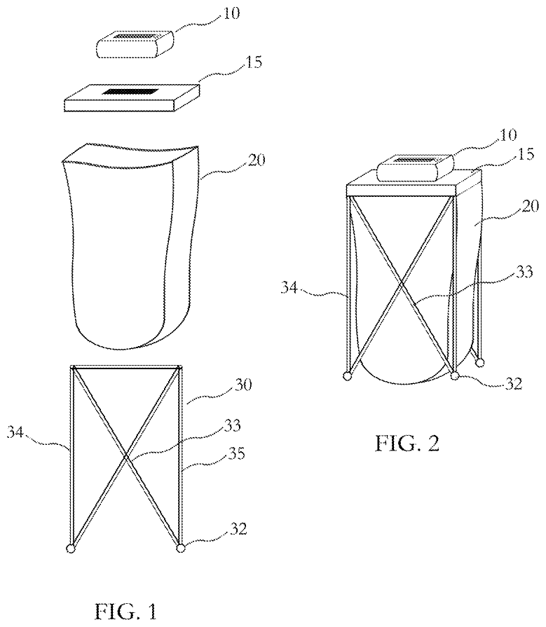

In reference to FIG. 1, a shredder assembly in accordance with the present invention is depicted. The depiction shows the components of the shredder assembly in particular a frame 30 and a base 15 that provides a means to mount the shredder. The base 15 further includes an opening that allows for the movement of shredded paper into a bag 20 as shown in FIG. 1. The bag 20 fits over the frame 30 as shown. The frame 30 includes a top support 36 and vertical supports 34, 35. Between the vertical supports 34, 35, a cross bar support 33 is provided to further support of the overall frame 30. Preferably the frame 30 includes wheels 32 that enable the movement of the shredder assembly as needed.

FIG. 2 depicts the shredder assembly in a composite form. As shown, the base 15 fits over a top support frame 36. This top support frame 36 supports the base 15 as the shredder 10 is placed over the opening provided in the base 15. The user shreds documents through the shredder 10 and the bag 20 receives the residue and waste created by the shredder 10. The frame 30 supports the bag 20, base 15 and shredder 10 during use. Conveniently a user may remove the base 15 to change the bag as needed. Also, shown are the wheels 32 as provided at the bottom of each vertical support 34, 35.

The present invention provides a compact portable shredder that may be used in various businesses to perform the necessary shredding as needed. The instant invention has been shown and described in what it considers to be the most practical and preferred embodiments. It is recognized, however, that departures may be made there from within the scope of the invention and that obvious modifications will occur to a person skilled in the art.

What is claimed is:

1. A shredder assembly for shredding paper comprising:
a. a frame;
b. a bag;
c. a base, where the base engages the frame and bag during use;
d. an opening within the base; and
e. a shredder positioned over the opening.

2. The shredder assembly according to claim 1, where the frame includes a top support that receives and supports the base.

3. The shredder assembly according to claim 1, where the frame includes vertical supports and a cross bar support between the vertical supports.

4. The shredder assembly according to claim 3, where wheels are mounted under the vertical supports.
